(19) United States
(12) Patent Application Publication
(10) Pub. No.: US 2019/0328049 A1
(43) Pub. Date: Oct. 31, 2019

(54) ADHESIVE BRA

(71) Applicant: Robyn Norris Casady, Pacific Palisades, CA (US)

(72) Inventor: Robyn Norris Casady, Pacific Palisades, CA (US)

(21) Appl. No.: 15/962,203

(22) Filed: Apr. 25, 2018

(51) Int. Cl. A41C 3/06; A41C 3/12; A41C 3/00

(52) U.S. Cl. CPC A41C 3/065; A41C 3/12; B32B 5/028; B32B 2405/00; A41C 3/0078

(57) ABSTRACT

A bra has a flexible sheet that includes a top surface and a bottom surface which extend to a perimeter. The flexible bra sheet extending laterally so that the flexible bra sheet has a width that is greater than a distance between a woman's nipples. An adhesive layer covers at least part of the bottom surface of the flexible bra sheet. Nipple covering portions are formed on the bottom surface of the flexible bra sheet.

### BACKGROUND OF THE INVENTION

### Field of the Invention

This invention relates generally to bras, and more particularly to an adhesive bra that does not extend around a woman's back or shoulders, but it held in place with an adhesive.

### Description of Related Art

Prior art bras include cups for receiving the woman's breasts and covering the nipples, and include straps that go over the woman's shoulders and around her chest for securing the cups. Negative health benefits have been found to arise from the constrictive nature of standard bras.

There is a need in the market for a bra that provides modesty and some level of support to a woman's breasts, without constricting the woman's chest and giving rise to health problems. The present invention fulfills these needs and provides further advantages as described in the following summary.

### SUMMARY OF THE INVENTION

The present invention teaches certain benefits in construction and use which give rise to the objectives described below.

The present invention provides a bra comprising a flexible bra sheet having a top surface and a bottom surface that extend to a perimeter, the flexible bra sheet extending laterally so that the flexible bra sheet has a width that is greater than a distance between a woman's nipples. An adhesive layer covers at least part of the bottom surface of the flexible bra sheet. Nipple covering portions are formed on the bottom surface of the flexible bra sheet.

A primary objective of the present invention is to provide a bra having advantages not taught by the prior art.

Another objective is to provide a bra that does not extend around a woman's back or shoulders, but it held in place with an adhesive.

A further objective is to provide a bra that provides support without constricting the woman's body, and in particular not compressing against the woman's lymph nodes, or otherwise causing negative health effects which may be caused by traditional bras.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a front perspective view of an adhesive bra according to a first embodiment of the present invention, illustrating a woman wearing the adhesive bra;

FIG. 2 is a front perspective view of the adhesive bra;

FIG. 3 is a rear perspective thereof; and

FIG. 4 is a front perspective view of woman wearing a second embodiment of the adhesive bra; and

FIG. 5 is a rear elevation view of the adhesive bra of FIG. 4.

### DETAILED DESCRIPTION OF THE INVENTION

The above-described drawing figures illustrate the invention, an adhesive bra that provides support and modesty without the constriction and other disadvantages related to the use of standard bras.

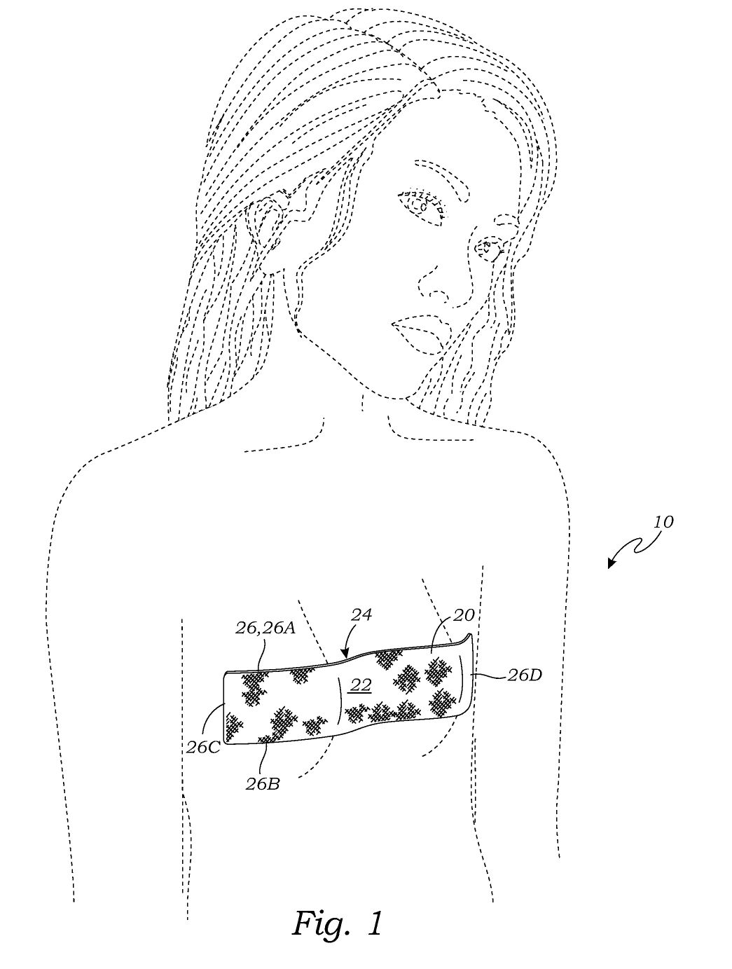

FIG. 1 is a front perspective view of an adhesive bra 10 according to a first embodiment of the present invention, illustrating a woman wearing the adhesive bra 10. As shown in FIG. 1, the adhesive bra 10 does not encircle a woman's back or shoulders, but is positioned across the woman's chest, and is held in place with an adhesive, as discussed in greater detail below. The adhesive bra 10 provides modesty by covering the woman's nipples, and the adhesive bra 10 may provide support by connecting the woman's breasts, in one embodiment pulling the breasts together.

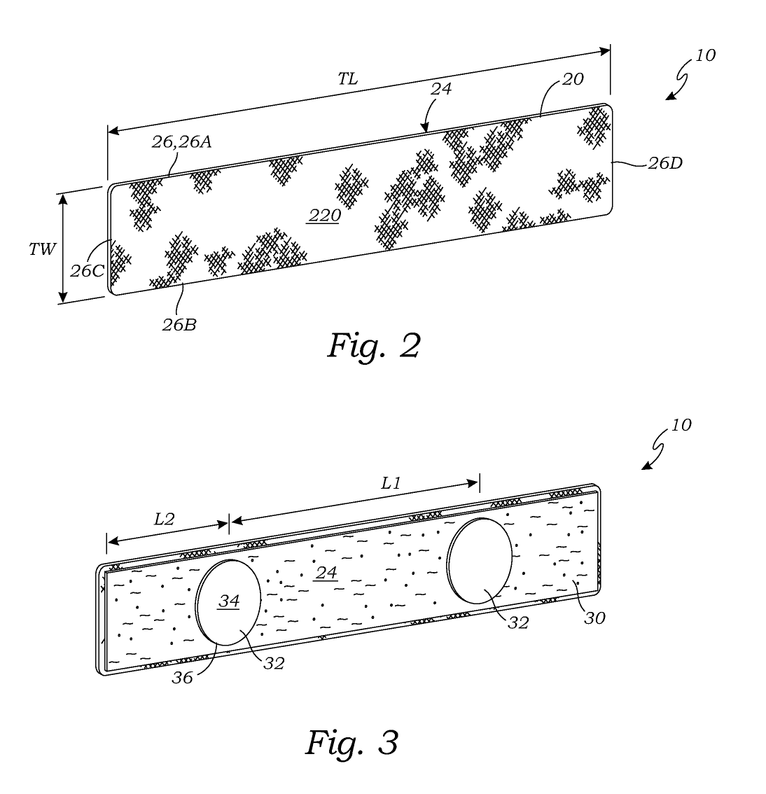

FIG. 2 is a front perspective view of the adhesive bra 10 of FIG. 1, and FIG. 3 is a rear perspective thereof. As shown in FIGS. 1-3, the bra 10 comprises a flexible bra sheet 20 having a top surface 22 and a bottom surface 24 that extend to a perimeter 26. As shown in FIGS. 1-3, in this embodiment, the perimeter 26 of the flexible bra sheet 20 includes a top edge 26A, an opposed bottom edge 26B, and opposed side edges 26C and 26D. The side edges 26C and 26D are approximately perpendicular to the top and bottom edges 26A and 26B.

The flexible bra sheet 20 is flexible, and in some embodiments may be elastic. In one embodiment, the flexible bra sheet 20 is a synthetic mesh. In another embodiment, it may be made of cotton, a cotton/synthetic blend, a synthetic fabric or other material, paper, or other material that may be selected by one skilled in the art as suitable for the present invention. In one embodiment, a combination of elastic and inelastic fibers, covered by cotton or similar fibers, may be used.

The flexible bra sheet 20 is planar in construction, and does not include three dimensional structure such as cups that are used in prior art bras. The flexible bra sheet 20 is of single piece construction, and is preferable formed of a single sheet of material.

In the embodiment of FIGS. 1-3, the flexible bra sheet 20 extends laterally so that the flexible bra sheet has a length TL (shown in FIG. 2) that is greater than a distance L1 (shown in FIG. 3) between the woman's nipples. In the embodiment of FIGS. 1-3, the flexible bra sheet 20 has a width TW (shown in FIG. 2) that is great enough to cover the woman's nipples, but can otherwise vary according to the desires of the woman. In this embodiment, the length TL is 9-13 inches (currently about 10.5 inches), and the width TW is about 1-3 inches (currently about 1.75 inches). In this embodiment, the flexible bra sheet 20 is rectangular; however, in alternative embodiments, the sheet 20 have alternative shapes, one of which is discussed in greater detail below.

As shown in FIG. 3, an adhesive layer 30 covers at least part of the bottom surface 24 of the flexible bra sheet 20. In the preferred embodiment, the entirety of the bottom surface 24 is covered by the adhesive layer 30, although in other embodiments, portions of the bottom surface may remain uncovered for comfort.

In this embodiment, as shown in FIG. 3, the flexible bra sheet 20 further has nipple covering portions 32 that protect the woman's nipples while wearing the bra 10. The nipple covering portions 32 of this embodiment are in the form of a soft covering material (e.g., cotton, synthetic, silicone or other material) that adheres to the adhesive layer 30, and may be in the form of a disk or other suitable construction. In another embodiment, the nipple covering portions 32 may be in the form of a gel, essential oil, or other similar material that is applied over the adhesive layer 30. In another embodiment, the nipple covering portions 32 are places where the adhesive layer 30 is not applied, so that the adhesive does not contact the woman's nipples, and a portion of the flexible bra sheet 20 forms the nipple covering portions 32. In yet another embodiment, the woman may apply an oil, gel, lubricant, or other material to her nipples prior to wearing the bra 10.

In this embodiment, the adhesive layer 30 is a low-tack pressure sensitive adhesive. In one embodiment, the adhesive layer 30 includes an amphiphilic copolymer of at least one hydrophobic acrylic monomer or oligomer; at least one hydrophilic or amphiphilic monomer or oligomer; and a crosslinker. In one embodiment, the hydrophilic or amphiphilic monomer or oligomer is selected from acrylamides, N-alkylacrylamides, N,N-dialkylacrylamides, N-alkylaminoalkylacrylamides, methacrylamides, amino methacrylates, N-alkylamino acrylates, N,N-dialkylamino acrylates, N-alkylamino methacrylates, acrylamido alkylsulfonic acid and its salts, N-vinylpyrrolidones, N-vinylcaprolactams, and combinations thereof; and the crosslinker is selected from polybutadiene dimethacrylate, trimethyolpropane trimethacrylate, and ethylene glycol dimethacrylate.

In one embodiment, the adhesive layer 30 includes 55 to 75% of a continuous phase and from 25 to 45% of a discontinuous phase. In this embodiment, the discontinuous phase includes hydrophilic polymers in the form of hydrocolloids, and the continuous phase containing from 5 to 10% of a texture copolymer consisting of a styrene-isoprene-styrene or styrene-butadiene-styrene-type block copolymer, a tackifying agent, and a plasticiser (percentages being given relative to the composition as a whole). The adhesive layer 30 may to further include essential oils, fragrances, and/or other additives that are beneficial to the woman wearing the bra 10.

In one implementation, the adhesive layer 30 may include any adhesive which will allow the bra 10 to adhere to the skin of a user without irritating the user's skin. In particular, the main ingredient can include a single compound or a mixture of compounds. For example, the main ingredient can include polyacrylate. Additionally or alternatively, the adhesive can include a solvent which is configured to evaporate or break down after application of the adhesive, leaving the main ingredient behind. For example the adhesive can include about 50% of the main ingredient with the rest of the adhesive comprising solvent. In at least one implementation, the solvent can include ethyl acetate.

The bra 10 is adapted to be easily applied and removed, and to provide support without constricting the woman's body, and in particular not compressing against the woman's lymph nodes, or otherwise causing negative health effects which may be caused by traditional bras.

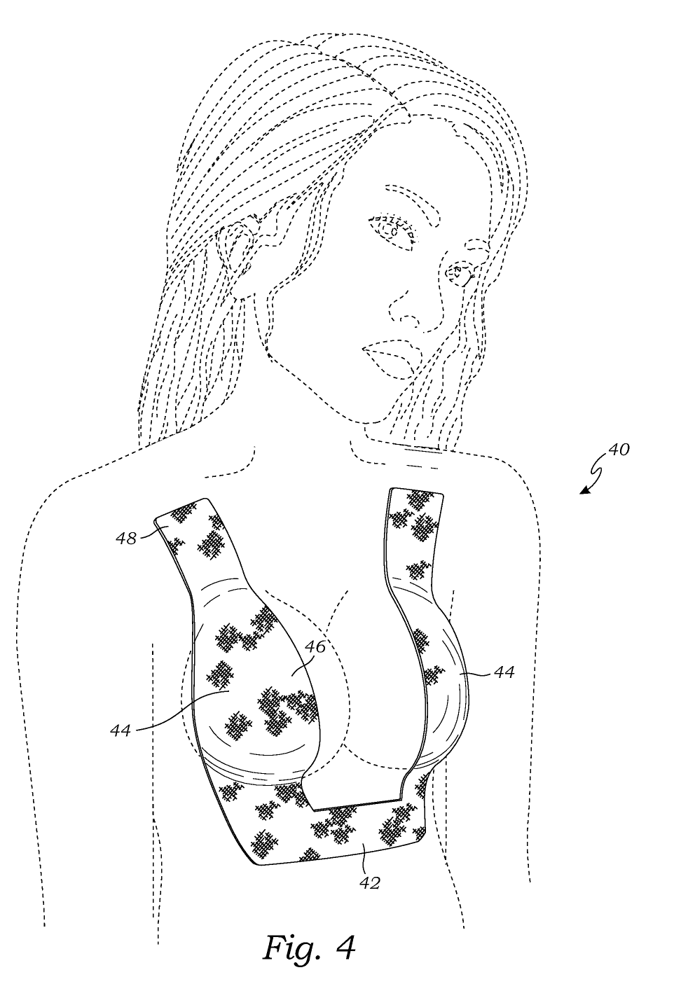

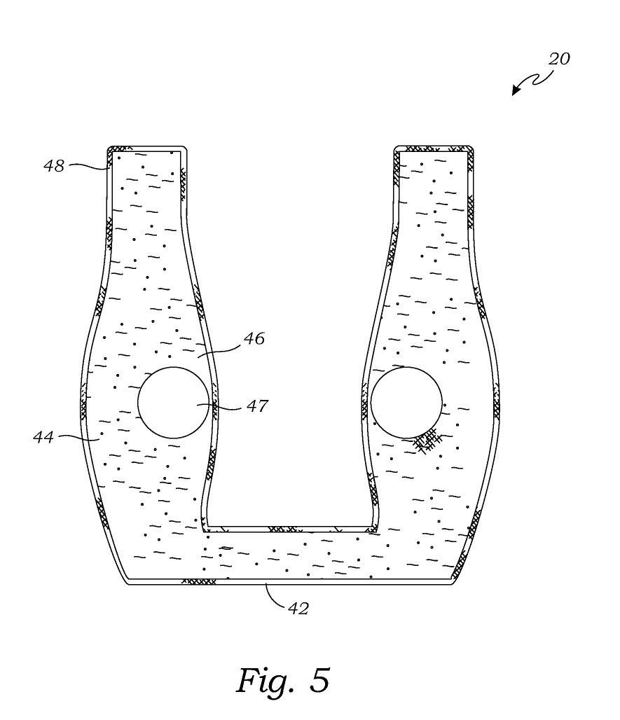

FIG. 4 is a front perspective view of woman wearing a second embodiment of the adhesive bra 40. FIG. 5 is a rear elevation view of the adhesive bra of FIG. 4. As shown in FIGS. 4-5, in this embodiment the adhesive bra 40 includes a lateral strip 42 and a pair of upwardly extending vertical strips 44 that extend upwardly to top ends 48. The top ends 48 extend up the chest, but preferably don't extend over the tops of the shoulders when worn. Similarly, the lateral strip 42 preferably does not extend around the woman's sides or back, and therefore cannot constrict the woman's body. The vertical strips 44 each form a breast covering portion 46 that cover at least part of one of the woman's breasts. As shown in FIG. 5, the breast covering portion 46 includes a nipple covering portion 47, as discussed in greater detail below.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by the following claims.

What is claimed is:

1. A bra comprising:
a flexible bra sheet having a top surface and a bottom surface that extend to a perimeter, the flexible bra sheet extending laterally so that the flexible bra sheet has a length that is greater than a distance between a woman's nipples; and
an adhesive layer covering at least part of the bottom surface of the flexible bra sheet.

2. The bra of claim 1, wherein the flexible bra sheet is rectangular.

3. The bra of claim 1, wherein the flexible bra sheet is U-shaped.

4. The bra of claim 1, wherein the flexible bra sheet is a synthetic mesh.

5. The bra of claim 1, wherein the adhesive layer is a pressure sensitive adhesive.

6. The bra of claim 1, further comprising nipple covering portions formed on the bottom surface of the flexible bra sheet.

7. The bra of claim 6, wherein the nipple covering portions are cotton.

8. The bra of claim 1, wherein the length is between 9-13 inches.

9. A bra comprising:
a flexible bra sheet having a top surface and a bottom surface that extend to a perimeter, the flexible bra sheet extending laterally so that the flexible bra sheet has a width that is greater than a distance between a woman's nipples;
an adhesive layer covering at least part of the bottom surface of the flexible bra sheet; and
nipple covering portions formed on the bottom surface of the flexible bra sheet.

10. The bra of claim 9, wherein the flexible bra sheet is rectangular.

11. The bra of claim 9, wherein the flexible bra sheet is U-shaped.

12. The bra of claim 9, wherein the flexible bra sheet is a synthetic mesh.

13. The bra of claim 9, wherein the adhesive layer is a pressure sensitive adhesive.

14. The bra of claim 9, wherein the nipple covering portions are cotton.

15. The bra of claim 1, wherein the length is between 9-13 inches.
